(19) United States
(12) Patent Application Publication
(10) Pub. No.: US 2007/0002704 A1
(43) Pub. Date: Jan. 4, 2007

(54) Optical head and optical disc apparatus

(76) Inventors: Sumitaka Maruyama, Yokohama-shi (JP); Kazuo Watabe, Yokohama-shi (JP); Nobuaki Kaji, Yokohama-shi (JP); Akihito Ogawa, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/479,738

(22) Filed: Jun. 30, 2006

(30) Foreign Application Priority Data
Jun. 30, 2005 (JP) 2005-193145

(51) Int. Cl. G11B 7/00

(52) U.S. Cl. 369/44.41

(57) ABSTRACT

To improve the quality of a tracking error signal when reproducing information recorded in an optical disc having tracks with two or more different pitches, using a diffraction element which is given a diffraction pattern configured to provide diffracted rays on the light-receiving surface of a photodetector which receives a reflected laser beam reflected on the recording layer of an optical disc and outputs a corresponding signal, to use diffracted rays generated according to pitches of optical tracks of an optical disc having different track pitches by switching to a predetermined combination in each of a phase different detection method (DPD) and a push pull method (PP).

### CROSS-REFERENCE TO RELATED APPLICATIONS

This application is based upon and claims the benefit of priority from Japanese Patent Application No. 2005-193145, filed Jun. 30, 2005, the entire contents of which are incorporated herein by reference.

### BACKGROUND

1. Field

One embodiment of the invention relates to an information recording/reproducing apparatus (optical disc apparatus) for recording, reproducing and erasing information on/from a recordable, reproduceable and erasable optical disc by using a laser beam, and an optical pickup (optical head) used in the optical disc apparatus.

2. Description of the Related Art

An optical disc is widely used as a recording medium suitable for recording, reproducing and erasing (recording repeatedly) information. Various optical discs of different specifications are proposed and used actually. By the recording capacity, these optical discs are classified into CD and DVD. By the uses (data-recording systems), the discs are sorted into a read-only type containing prerecorded information (called a ROM), a write once type capable of recording information only once (called a -R), and a rewritable type capable of recording and erasing information repeatedly (called a RAM or RW).

As the specification and purpose of an optical disc have been diversified, an optical disc recording/reproducing apparatus is required to be capable of recording information on an optical disc of two or more specifications, reproducing prerecorded information, and erasing recorded information. Besides, it is demanded as an essential condition of an optical disc recording/reproducing apparatus to be capable of detecting a specification of an optical disc set in the apparatus, even if it is difficult to record and erase information.

Therefore, an optical pickup incorporated in an optical disc information recording/reproducing apparatus is required at least to be capable of capturing a reflected light from tracks or a string of record marks peculiar to an optical disc and controlling the tracks and focus of an object lens (optical pickup), regardless of the specifications (types) of an optical disc.

It is disclosed by, for example, Japanese Patent Application Publication (KOKAI) No. 2004-39165 proposes a method of obtaining a tracking signal by dividing a reflected ray from an optical information recording medium (optical disc) into parts where 0^{th} and ±1^{st} diffracted rays are overlapped and not overlapped, applying a reflected light to independent optical detection means, and obtaining a predetermined signal.

However, the diffraction angle of the ±1^{st} diffracted ray of the reflected light from the optical information recording medium described in the above Publication is different according to a wavelength of a reflected light, a track pitch of an optical information recording medium, etc.

Therefore, in a pickup unit which receives reflected light with different wavelengths, reflected light from tracks of different types of optical information recording media, or reflected light when tracks with two or more pitches exist in one optical information recording media, it is impossible to uniquely determine the parts where 0^{th} and 1^{st} diffracted rays are overlapped and not overlapped.

On the other hand, an optical dividing means based on the wavelength and track pitch of any one reflected light is difficult to generate a normal track error signal from a reflected light from optical information recording media with different wavelengths and track pitches.

When two or more track pitches exist in one optical information recording medium, it is known that the system described in the above Application is difficult to obtain a correct DPD signal because of the influence of zero cross different from that to be used for a DPD signal.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of an optical disc apparatus (an information recording/reproducing apparatus) in accordance with an embodiment of the invention;

FIG. 2 is an exemplary diagram showing an example of a pattern of dividing a luminous flux by a diffraction element (hologram) and a pattern of a light-receiving area of a photodiode (photodetector), used in an optical head unit incorporated in the optical disc apparatus shown in FIG. 1;

FIGS. 3A to 3C are graphs each explaining conditions to define a hologram shown in FIG. 2;

FIG. 4 is a graph explaining conditions to define a comparing example of a DPD (tracking error) signal for explaining the function of the hologram shown in FIG. 2;

FIG. 5 is a graph explaining an example of a DPD (tracking error) signal obtained by using the hologram shown in FIG. 2; and

FIG. 6 is a graph explaining an example of a luminous flux dividing pattern by a diffraction element (hologram) used in an optical head unit incorporated in the optical disc apparatus shown in FIG. 1, and a pattern of a light-receiving area of a photodiode (photodetector).

### DETAILED DESCRIPTION

Various embodiments according to the invention will be described hereinafter with reference to the accompanying drawings. In general, according to one embodiment of the invention, using a diffraction element which is given a diffraction pattern configured to provide diffracted rays on the light-receiving surface of a photodetector which receives a reflected laser beam reflected on the recording layer of an optical disc and outputs a corresponding signal, to use diffracted rays generated according to pitches of optical tracks of an optical disc having different track pitches by switching to a predetermined combination in each of a phase different detection method (DPD) and a push pull method (PP).

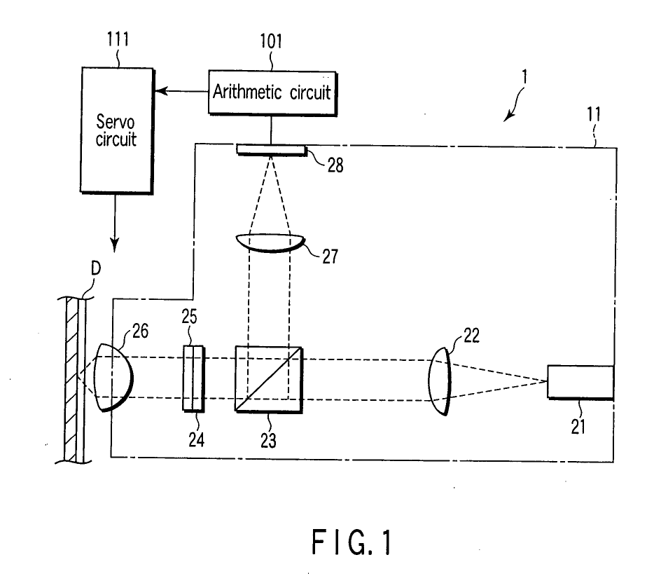

According to an embodiment, FIG. 1 shows an example of an optical disc apparatus having an optical head unit, or an information recording/reproducing apparatus, according to an embodiment of the present invention.

An information recording/reproducing apparatus or an optical disc apparatus 1 shown in FIG. 1 can record or reproduce information on/from an optical disc D by condensing a laser beam emitted from a PUH (optical pickup head, hereinafter called an optical head unit) 11 on the information-recording layer of the optical disc D, or a recording medium.

The optical disc D is held on a not-shown turntable of a not-shown disc motor (to rotate the turntable), and rotated at a fixed speed by the rotation of the disc motor at a fixed speed.

The PUH (optical head unit) 11 is moved by a not-shown pickup sending motor in the radial direction of the optical disc D at a predetermined speed, when recording, reproducing or erasing information.

The optical head unit 11 includes a light source, for example a laser diode (LD) 21 that is a semiconductor laser element. The wavelength of a laser beam output from the laser diode (light source) 21 is 400 to 410 nm, preferably 405 nm.

The laser beam from the semiconductor laser diode 21 is collimated (paralleled) by a collimator lens 22, transmitted through a polarization beam splitter (PBS) 23, an optical dividing element or a hologram plate (hologram optical element (HOE)) 24 and a λ/4 plate (¼ wavelength plate or polarization control element) 25 which are provided at predetermined positions, and given a predetermined convergence by a condensing element or an object lens (OL) 26. The object lens 26 is made of plastic, and has a numerical aperture (NA) of 0.65, for example.

The laser beam given a predetermined convergence by the object lens 26 passes through a cover layer of an optical disk (not described in detail), and condensed on a recording layer (or a place nearby). The laser beam from the light source 21 provides a minimum optical spot at a focal position of the object lens 26.

Though not described in detail, the minimum optical spot of the laser beam is condensed on the recording layer of the optical disc D by moving the object lens 26 (optical head unit 11) in the direction orthogonal to the recording surface, so that the distance from the object lens 26 to the recording surface of the optical disc D becomes the same as the focal distance of the object lens 26.

The laser beam reflected on the recording surface of the optical disc D is captured by the object lens 26, converted to a beam having a substantially parallel section by the object lens 26, and returned to a polarization beam splitter 23.

The reflected laser beam returned to the polarization beam splitter 23 is reflected on the polarization surface (not described in detail) of the polarization beam splitter 23, because the polarization direction of the laser beam toward the optical disc D is rotated 90 degrees by being passed through the ¼ wavelength plate 25.

The laser beam reflected on the polarization beam splitter 23 is focused as an image on the light-receiving surface of the photodiode (photodetector (PD)) 28 through a focusing lens 27.

The reflected laser beam is divided into a predetermined form and predetermined number of portions to meet the form and arrangement of a detection area (light-receiving area) formed on the light-receiving surface of the photodetector 28 provided in a later stage.

The light-receiving part of the photodetector 28 is usually divided into several light-receiving (detection) areas, which outputs a current corresponding to a light intensity.

The current output from each light-receiving area is converted to a voltage by a not-shown I/V amplifier, applied to an arithmetic circuit (signal processor) 101, and processed to be usable as a HF (reproducing) signal, a track error signal and a focus error signal. Though not described in detail, the HF (reproducing) signal is converted to a predetermined signal format, or output to a temporary storage device or external storage device through a predetermined interface.

The signal obtained by the arithmetic circuit 101 is also used as a servo signal to move the object lens 26 of the optical head apparatus 11 through the servo circuit 111, in the direction (optical axis direction) orthogonal to the surface of the optical disc D including the recording surface so that the distance from the object lens 26 to the recording surface of the optical disc D becomes the same as the focal distance of the object lens 26, and in the direction orthogonal to the direction of a track or record mark (string) formed on the recording surface of the optical disc.

The servo signal is generated based on a tracking error signal indicating the changing of the position of the object lens 26, by a known focus error detection method, so that an optical spot having a predetermined size at a focal position of the object lens 26 becomes a predetermined size on the recording layer of the optical disc 1, and based on a tracking error signal indicating the changing of the position of the object lens 26, by a known track error detection method, so that the optical spot is guided to substantially the center of a record mark string or track.

The object lens 26 is controlled to provide an optical spot condensed by the object lens 26 at a minimum size on a not-shown recording layer of the optical disc D at the focal distance, at substantially the center of a track or record mark string formed on the recording layer of the optical disc D.

More specifically, the laser beam emitted from the semiconductor laser (LD) 21 is collimated by the collimator lens 22. This laser beam is a linearly polarized light, passed through the PBS (polarization beam splitter) 23 and hologram (HOE) 24, applied to the ¼ wavelength plate 25 and circularly changed (rotated) in the plane of polarization, and given a predetermined convergence by the object lens 26, and condensed on the recording surface of the optical disc D.

The laser beam condensed on the recording surface of the optical disc D is optically modulated (reflected or diffracted) by a record mark, for example a pit (a pit string) formed on the recording surface, or a groove.

The laser beam reflected or diffracted on the recording surface of the optical disc is paralleled again by the object lens 26, passed again through the ¼ wavelength plate 25, and returned to the hologram (HOE) 24 by changing the polarization direction 90 degrees from that in the going path.

The hologram 24 is given a pattern which acts only on a polarized beam (reflected laser beam) in a returning path, and divides a laser beam (reflected laser beam) in a returning path into several luminous flux, and deflections them in a predetermined direction (changes the distance from the center for each divided laser beam, toward the light-receiving area of a photodetector provided corresponding to each laser beam).

The reflected laser beam changed by 90 degrees in the going and returning paths of polarization and divided into a predetermined number as described above is reflected on the polarization surface of the PBS (polarization beam splitter), and condensed in the light-receiving area (described later) of the photodetector 28 through the focusing lens 27.

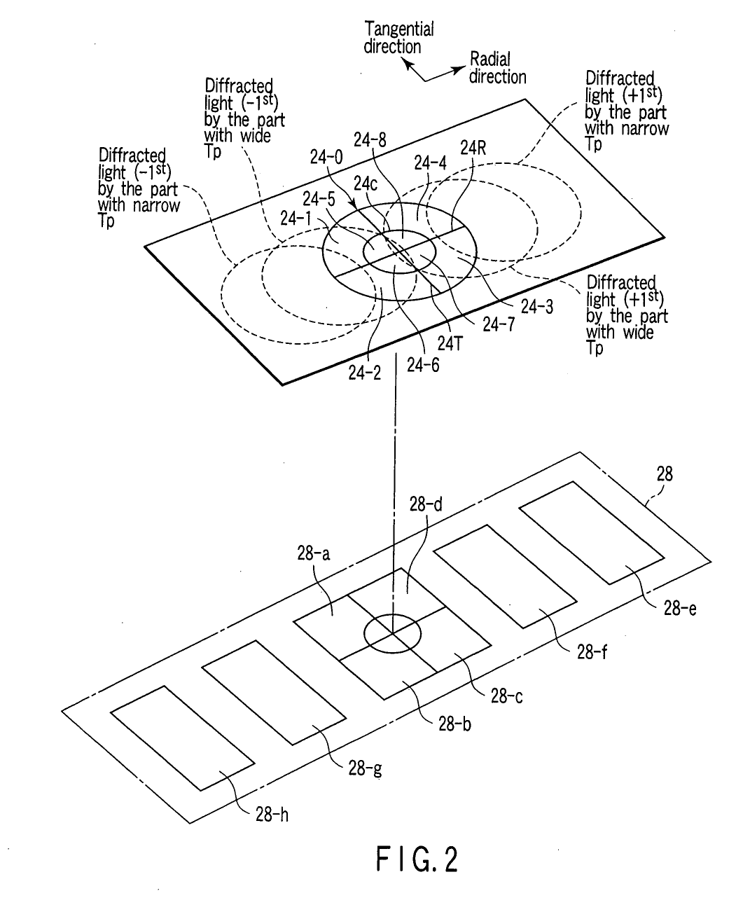

FIG. 2 shows an example of a pattern of dividing a luminous flux by a hologram element incorporated in the optical head of the optical disc apparatus shown in FIG. 1, and characteristics of arrangement and form (a pattern of arrangement) of light-receiving areas of a photodiode (photodetector).

As shown in FIG. 2, the hologram (HOE) 24 has a substantially circular pattern 24-0. The pattern 24-0 is divided into first to fourth areas 24-1 to 24-4 around the intersection of a boundary line 24R (radial direction) passing at substantially the center of the pattern and a boundary line 24T (tangential direction) orthogonal to the boundary line 24R. The pattern 24-0 includes a substantially circular concentric boundary line 24C, which defines fifth to eighth areas 24-5 to 24-8 in the first to fourth areas (close to the center). The boundary line 24R extends in the radial direction orthogonal to a not-shown track (guide groove) or a string of record mark (tangential direction) previously formed concentrically or spirally to the recording surface of an optical disc D.

Optical beams diffracted by the first to fourth areas 24-1 to 24-4 and fifth to eighth areas 24-5 to 24-8 are used for a differential phase detection (DPD) method in the areas defined in the same sections (mathematically quadrants) divided by the boundary lines 24R and 24T. Namely, the diffracted optical beams are used for a first tracking error detection method for generating a tracking error signal indicating deviation of a laser beam condensed on the recording surface of the optical disc D through the object lens 26 from the position of the guide groove or record mark string formed previously on the recording surface.

The optical beams diffracted by the first to fourth areas 24-1 to 24-4 are used for generation of a tracking error signal of a push pull (PP) method as a second tracking error detection method.

The optical beams (laser beams) divided by the above-mentioned diffraction pattern (HOE) 24 are condensed respectively in the 4-divided light-receiving areas 28-a to 28-d and 4-divided independent light-receiving areas 28-e to 28-h spaced in the radial direction of the photodetector 28.

Namely, the optical beam (diffracted beam) diffracted by the diffraction pattern 24-1 is focused on the light-receiving area 28-h, the optical beam (diffracted beam) diffracted by the pattern 24-2 is focused on the light-receiving area 28-g, the optical beam (diffracted beam) diffracted by the pattern 24-3 is focused on the light-receiving area 28-f, and the optical beam (diffracted beam) diffracted by the pattern 24-4 is focused on the light-receiving area 28-e, respectively.

The optical beam (diffracted beam) diffracted by the diffraction pattern 24-5 is focused on the light-receiving area 28-a, the optical beam (diffracted beam) diffracted by the pattern 24-6 is focused on the light-receiving area 28-b, the optical beam (diffracted beam) diffracted by the pattern 24-7 is focused on the light-receiving area 28-c, and the optical beam (diffracted beam) diffracted by the pattern 24-8 is focused on the light-receiving area 28-d, respectively.

Assuming that the outputs of the light-receiving areas 28-a to 28-h are Pa to Ph, a tracking error signal PP by the push pull (PP) method is obtained by
PP=(Pe+Pf)−(Pg+Ph) (1)

A tracking error signal DPD (hereinafter called simply a DPD) by the phase difference detection method (DPD) is obtained by
DPD=Ph(Ph+Pa+Pf+Pc)−Ph(Pg+Pb+Pe+Pd) (2).

The size of the boundary line 24C defined concentrically in the pattern 24-0 is determined by the pitch of the guide groove (track) formed previously on the recording surface of the optical disc (recording medium) D reproducible by the optical disc apparatus 1.

When a reproducible optical disc is of a common DVD specification, a track pitch is 0.68 μm, for example.

When a reproducible optical disc is of a HD DVD specification with the recording density higher than a current DVD specification optical disc, a track pitch in data area tracks is 0.3 to 0.7 μm, for example, 0.34 to 0.44 μm, typically 0.40 μm in many cases. In an optical disc of a HD DVD specification, a track pitch in a system lead-in area is determined to 0.68 μm.

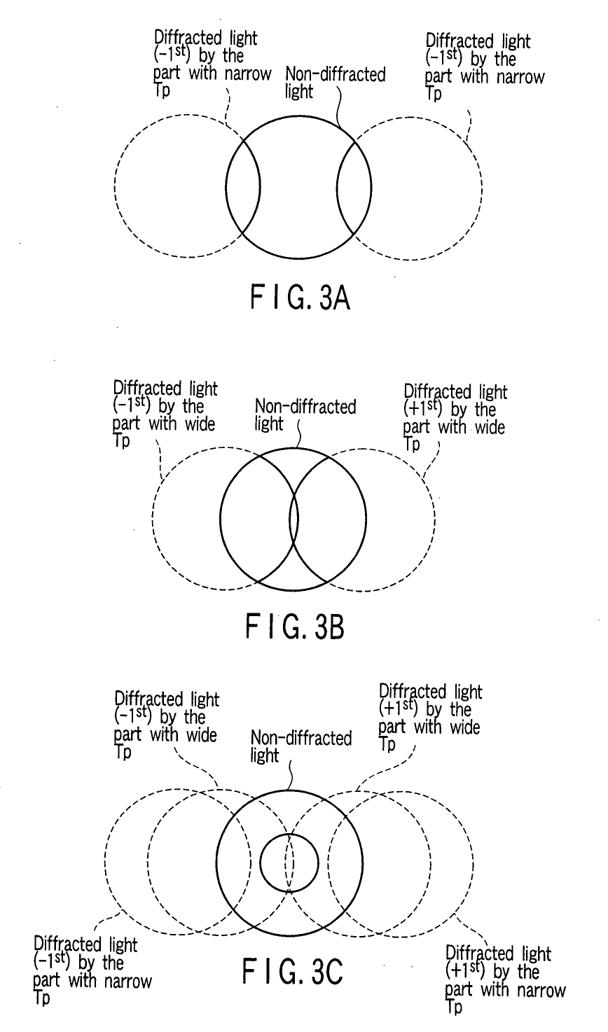

FIGS. 3A to 3C indicates a method of defining the above-mentioned track pitch and the size of a concentric boundary line (boundary circle 24C) of the hologram shown in FIG. 2. FIG. 3A schematically shows a diffracted beam of a reflected laser beam from an optical disc provides a narrow track pitch Tp or a part of the optical disc with a narrow track pitch Tp as an example of a condensing pattern in a photodetector. FIG. 3B schematically shows a diffracted beam of a reflected laser beam from an optical disc provides a wide track pitch Tp or a part of the optical disc with a wide track pitch Tp as an example of a condensing pattern in a photodetector.

When assuming Tp=0.4 μm for an optical disc or a part of it with a narrow track pitch Tp, for example, a non-diffracted beam is partially overlapped with diffracted beams in a reflected laser beam from an optical disc as shown in FIG. 3A, and the diffracted beams have a predetermined interval in a radial direction.

When assuming Tp=0.68 μm for an optical disc or a part of it with a wide track pitch Tp, a non-diffracted beam is partially overlapped with diffracted beams in a reflected laser beam from an optical disc as shown in FIG. 3B, and the diffracted beams have an overlapped area larger than the example shown in FIG. 3A, and are overlapped in a predetermined area in the radial direction.

The concentric boundary line 24C of the diffraction element shown in FIG. 2 is defined in an area, which includes the overlapped diffracted beams of the laser beam reflected from a track with a large track pitch Tp (Tp=0.68 μm) as explained in FIG. 3C, and does not include any of the diffracted beams of the laser beam reflected from a track with a narrow track pitch Tp (Tp=0.40 μm).

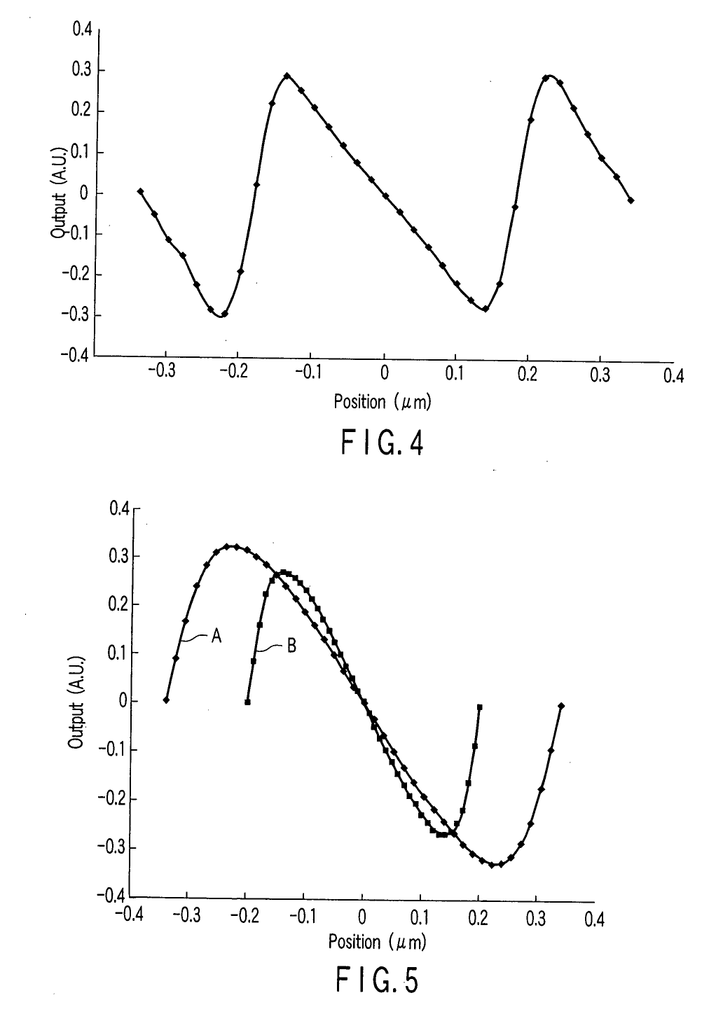

This is explained by that a zero cross signal is not only one set (one pair) as shown in FIG. 4, when getting a DPD signal in the state that the inside four patterns divided by the concentric boundary line 24C are removed for comparison from the diffraction patterns of the diffraction element 24 shown in FIG. 2. FIG. 4 is equivalent to the explanation in the prior art and the problems to be solved by the invention, and detailed explanation will be omitted.

FIG. 5 shows a DPD signal obtained by the photodetector and diffraction element of the invention explained in FIGS. 2, 3A, 3B, and 3C.

In FIG. 5, the curve A indicates a DPD signal from the track with a wide track pitch Tp (Tp=0.68 μm, or a system lead-in), and the curve B indicates a DPD signal from the track with a narrow track pitch Tp (Tp=0.40 μm, or a data area).

As seen from FIG. 5, the amplitude of the curve B is smaller than the curve A, and depends on the original track pitch. It proves that a problem of zero cross as shown in FIG. 4 does not occur in more than one set (pair).

According to the photodetector and diffraction element of the invention shown in FIGS. 2, 3A, 3B, and 3C, when the optical disc D is a rewritable type having a guide groove (track) on a recording layer, or a write once type, a compensated tracking error signal CPP (Compensated Push Pull, a third tracking error detection method) is obtained by
CPP=(Pg+Ph)−(Pe+Pf)−k(Pa+Pb−Pc−Pd) where, k is a compensation coefficient (3).

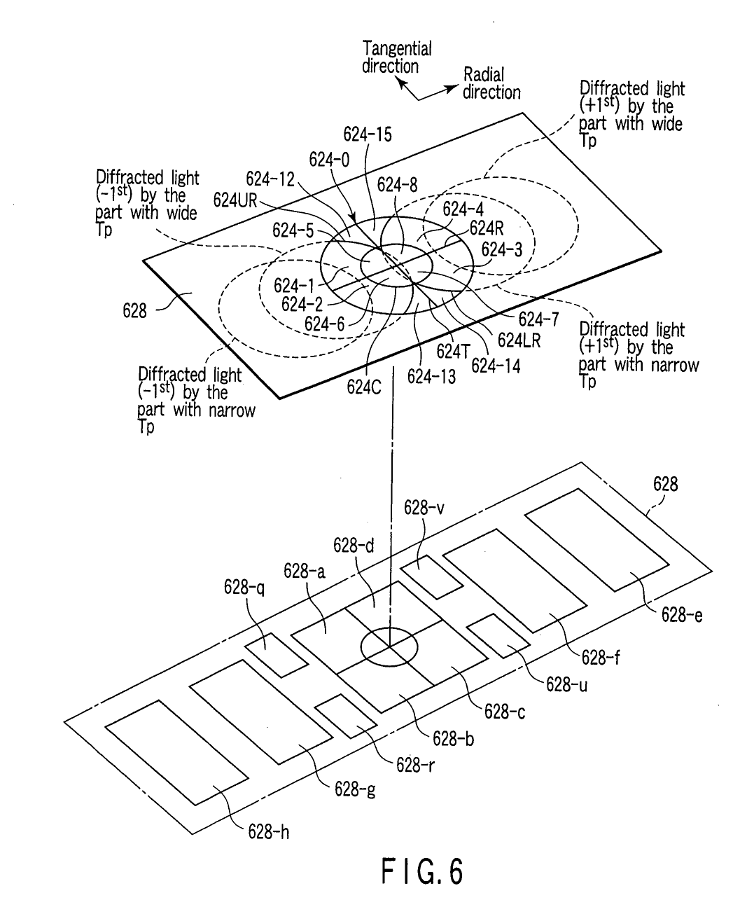

FIG. 6 shows another example of a pattern of dividing a luminous flux by a hologram element (diffraction grating) incorporated in the optical head of the optical disc apparatus shown in FIG. 1, and characteristics (arrangement pattern) of arrangement and form of light-receiving areas of a photodiode (photodetector). The example shown in FIG. 6 makes it possible to increase the S/N of PP (Push Pull) signal by modifying the diffraction pattern of the hologram explained in FIG. 2 and the corresponding arrangement of the light-receiving area of the photodetector.

As shown in FIG. 6, the hologram (HOE) 624 (600 is added for discrimination) has a substantially circular pattern 624-0, for example. The pattern 624-0 is divided into first to fourth areas 624-1 to 624-4 around the intersection of a boundary line 624R (radial direction) passing at substantially the center of the pattern and a boundary line 624T (tangential direction) orthogonal to the boundary line 624R. The pattern 624-0 includes a substantially circular concentric boundary line 624C, which defines fifth to eighth areas 624-5 to 624-8 in the first to fourth areas (close to the center). Further, the pattern 624-0 also includes ninth to twelfth areas 624-12 to 624-15 (the part defined moving the diffracted ray area up to the position where the boundary line 624C intersects with the boundary line 624T, or the area a non-diffracted ray passes through), which is the part where a non-refracted ray of the reflected laser beam from the optical disc D passes through, as explained in FIGS. 3A, 3B, and 3C and defined by boundary lines 624UR and 624LR formed by combining two arcs corresponding to the part where a diffracted ray is not overlapped.

The optical beams diffracted by the first to fourth areas 624-1 to 624-4 are used for generation of a tracking error signal for a push pull method. The reference numerals are identical to those explained in FIG. 2, but the ninth to twelfth areas 624-12 to 624-15 are omitted in each area (a beam is not applied to a light-receiving area of the corresponding photodetector).

The optical beams diffracted by the first to fourth areas 624-1 to 624-4 and fifth to eighth areas 624-5 to 624-8 are used for generation of a tracking error signal for a differential phase detection (DPD) method in the areas defined in the same sections (mathematically quadrants). As in the above PP signal, a part of the ninth to twelfth areas 624-12 to 624-15 is omitted in the ninth to twelfth areas 624-12 to 624-15 (a beam is not applied to a light-receiving area of the corresponding photodetector).

The beams passing through the ninth to twelfth areas 624-12 to 624-15 are usable to eliminate the influence of lens shift of the object lens 26.

The optical beams (laser beam) divided by the above-mentioned diffraction pattern are condensed respectively in the 4-divided light receiving areas 628a to 628d at substantially the center of the light-receiving surface of the photodetector 628, and the 4-divided independent light-receiving areas 628-e to 628-h spaced in the radial direction. The laser beams divided by the ninth to twelfth areas 624-12 to 624-15 are condensed respectively in the ninth to twelfth light-receiving areas 628-q, 626-r, 628-u and 628-v defined at predetermined positions close to the 4-divided light-receiving areas 628-a to 628-d of the photodetector 628.

Assuming that the outputs are Pa−Ph and Pq, Pr, Pu and Pv, respectively, a tracking error signal DPD by a phase difference detection method (DPD) is obtained by
DPD=Ph(Ph+Pa+Pq+Pf+Pc+Pu)−Ph(Pg+Pb+Pr+Pe+Pd+Pv) (4)

substantially the same as the equation (2).

A tracking error signal PP by the push pull method is obtained by
PP=(Pe+Pf)−(Pg+Ph) (5)

substantially the same as (1) and the components passing through the ninth to twelfth areas 624-12 to 624-15 are not included in the outputs.

A compensation tracking error signal CPP is obtained by
CPP=(Pg+Ph)−(Pe+Pf)−k{(Pa+Pb−Pc−Pd)+(Pq+Pr−Pu−Pv)} where, k is a compensation coefficient (6).

As for the equations (5) and (6), or the PP signal and CPP signal, the unused component is eliminated, and the output corresponds only to the offset component by the lens shift of the object lens 26. Therefore, comparing with the equation (3), the S/N as a compensation signal can be increased.

This means that by setting the value of k small, the optical disc D is hardly influenced by damages or dust made/adhered to the recording surface causing a reflected beam similar to a reflected laser beam from a guide groove (track) peculiar to the optical disc.

Therefore, it is possible to provide an optical disc apparatus difficult to be influenced by an optical disc with damages causing a signal similar to a guide groove (track) peculiar to an optical disc.

According to the equations (5) and (6), though the light-receiving areas 628-q, 628-r, 628-u and 628-v of the photodetector 628 seem unnecessary, they are useful for adding the outputs of all light-receiving areas to increase the HF (reproducing output) gain, when reproducing information from an optical disc of DVD specification using a laser beam with a wavelength of 405 nm, because the reproducing output is small.

As explained hereinbefore, by using a light-receiving optical system defined as an embodiment of the invention, the S/N in increased in a tracking error signal by a push pull method (PP, a second tracking error signal generation method) when reproducing information recorded in an optical disc (recording medium) having tracks with two or more different pitches, a tracking error signal by a phase difference method (DPD, a first tracking error signal generation method), and a compensation tracking error signal (CPP, a third tracking error signal generation method). A tracking error can be exactly detected in a system that a lens shift is superposed on an object lens.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the detailed description of the invention, an optical disc apparatus is taken as an example of embodiment of the invention. The invention is of course applicable also to a video camera and a portable acoustic apparatus to contain musical data.

What is claimed is:

1. An optical head unit comprising:
a condensing means which condenses light on the recording surface of a recording medium;
a dividing means which divides a reflected light reflected on the recording surface of the recording medium into several reflected rays including a common central part; and
an optical detection means which has several light-receiving areas configured to receive the reflected light divided by the dividing means,
wherein the dividing means includes an area which diffracts the reflected light in a predetermined direction to be usable for generating a tracking error signal to indicate displacement of the light condensed by the object lens from the position of a record mark string or guide groove of the recording medium by a first method using light including at least central part, and an area which diffracts the reflected light in a predetermined direction to be usable for generating a tracking error signal by a second method using light including areas different from the central part, and
the output from the optical detection means is switched to a predetermined combination in each of generating a tracking error signal by the first method and generating a tracking error signal by the second method.

2. The optical head unit according to claim 1, wherein the dividing means includes a peripheral area and a central area defined inside, and
an output corresponding to the light including at least the central part of the optical detection means and an output corresponding to the light including the areas different from the central part are used in a predetermined combination, when a tracking error signal is generated by the first method, and outputs from the areas of the optical detection means corresponding to the light including the areas different from the central part of the dividing means are used in a predetermined combination, when a tracking error signal is generated by the second method.

3. The optical head unit according to claim 1, wherein the dividing means includes a peripheral area and a central area defined inside, and
outputs from the areas of the optical detection means corresponding to the peripheral area of the dividing means are used in a predetermined combination, when a tracking error signal is generated by the second method, and an output of the area of the optical detection means corresponding to the central part area of the dividing means is used in a predetermined combination, when a tracking error signal is generated by a third method different from the first and second methods.

4. The optical head unit according to claim 1, wherein the dividing means includes a central area defined along the radial direction of the recording medium and a peripheral area defined outside a part of the central area, and a boundary of the central area and peripheral area is defined based on a pitch of a record mark string or guide groove peculiar to the recording medium.

5. The optical head unit according to claim 1, wherein the dividing means is defined based on a pitch of a record mark string or guide groove peculiar to the recording medium.

6. An optical head unit comprising:
an object lens which condenses light from a light source on a recording surface of a recording medium;
a diffraction element which divides a reflected light reflected on the recording surface of the recording medium into several rays along a radial direction of the recording medium, and gives at least one of the reflected rays a predetermined diffraction characteristic configured to set influence of the pitch of the record mark string or guide groove peculiar to the recording medium;
a photodetector which receives the reflected light divided by the diffraction by the diffraction element for each reflected rays, and outputs a signal corresponding to the light intensity of the divided reflected light;
an arithmetic means which calculates the output from the photodetector according to predetermined regulations; and
a signal processor which reproduces information recorded in the recording medium, based on the output from the photodetector corresponding to the light divided by the dividing means,
wherein the dividing means includes an area which diffracts the reflected light in a predetermined direction to be usable for generating a tracking error signal to indicate displacement of the light condensed by the object lens from the position of a record mark string or guide groove of the recording medium by a first method using light including at least central part, and an area which diffracts the reflected light in a predetermined direction to be usable for generating a tracking error signal by a second method using light including areas different from the central part, and
the arithmetic means is switched to a predetermined combination, in each of generating a tracking error signal by the first method and generating a tracking error signal by the second method.

7. The optical head unit according to claim 6, wherein the diffraction element includes a central area defined along the radial direction of the recording medium and a peripheral area defined outside a part of the central area, and a boundary of the central area and peripheral area is defined based on a track pitch peculiar to the recording medium.

8. The optical head unit according to claim 6, wherein the arithmetic means uses outputs of the light-receiving area of the optical detection means corresponding to the reflected light diffracted in all areas of the dividing means when a tracking error signal is generated by the first method, and uses outputs of the light-receiving areas of the optical detection means corresponding to the reflected light diffracted in the peripheral area of the dividing means when a tracking error signal is generated by the second method.

9. The optical head unit according to claim 6, wherein the arithmetic means uses outputs of the light-receiving areas of the optical detection means corresponding to the reflected light diffracted in the central part area of the dividing means, when a tracking error signal is generated by the third method used when the recording medium has a guide groove.

10. An optical disc apparatus comprising:
an optical head unit including;
a condensing means which condenses light on the recording surface of a recording medium;
a dividing means which divides a reflected light reflected on the recording surface of the recording medium into several reflected rays including a common central part; and
an optical detection means which has several light-receiving areas configured to receive the reflected light divided by the dividing means; and
a signal output unit which outputs a signal to control a distance from the object lens to a recording medium, and a relative position of light condensed on a recording medium by the object lens in a radial direction of the recording medium, based on the outputs of the optical detection means,
wherein the dividing means includes an area which diffracts the reflected light in a predetermined direction to be usable for generating a tracking error signal to indicate displacement of the light condensed by the object lens from the position of a record mark string or guide groove of the recording medium by a first method using light including at least central part, and an area which diffracts the reflected light in a predetermined direction to be usable for generating a tracking error signal by a second method using light including areas different from the central part, and
the output from the optical detection means is switched to a predetermined combination in each of generating a tracking error signal by the first method and generating a tracking error signal by the second method.
